(19) United States
(12) Patent Application Publication
(10) Pub. No.: US 2010/0254662 A1
(43) Pub. Date: Oct. 7, 2010

(54) CONNECTOR WITH IMPROVED CONTACTS

(75) Inventors: JIA-YONG HE, Kunshan (CN); QI-SHENG ZHENG, Kunshan (CN)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION INDUSTRY CO., LTD., Tu-Cheng (TW)

(21) Appl. No.: 12/753,056

(22) Filed: Apr. 1, 2010

(30) Foreign Application Priority Data
Apr. 2, 2009 (CN) 200910301299.3

(51) Int. Cl. G02B 6/38; H01R 24/00

(52) U.S. Cl. 385/75; 439/218

(57) ABSTRACT

A connector (100) having a reception opening (70) includes an insulative housing (9) having a tongue plate (91) and a set of contacts (2). The contacts include a set of first and second contacts (20, 30). Each first contact has a first contacting portion (25) and a first tail portion. Each second contact (30) has a second contacting portion (35) and a second tail portion. The first contacts include a first pair of differential contacts (23, 24). The second contacts include a second pair of differential contacts (31), a third pair of differential contacts (32), and a second grounding contact (33). Wherein the first tail portions of the first pair of differential contacts are arranged along a front-to-back direction and located between the second tail portions of the second pair of differential contacts and the second tail portions of the third pair of differential contacts.

### BACKGROUND OF THE INVENTION

1. Field of the Invention

The present invention relates to a connector, more particularly to connectors with improved contacts to be soldered to a printed circuit board (PCB).

2. Description of Related Art

U.S. Pat. No. 5,769,666 discloses an electrical connector including an insulative housing, a plurality of contacts retained in the housing and a metal shield received in the housing. The contacts include contact portions, retaining portions retained in the insulative housing and tail portions extending downwardly from rear ends of the retaining portions for being soldered to a PCB. The tail portions are perpendicular to the contact portions. The metal shield encloses the contact portions for EMI protection. The tail portions occupy much area of a rear wall of the housing because a width of the bending portion viewed from a rear-to-front direction is much larger than that viewed from a left-to-right direction. As a result, the rear wall of the housing doesn't have reasonable area for mounting components.

Hence, an improved connector is desired to overcome the above problems.

### BRIEF SUMMARY OF THE INVENTION

According to one aspect of the present invention, a connector having a reception opening for insertion of an electrical plug comprises: an insulative housing having a tongue plate extending into the reception opening; and a plurality of contacts retained in the insulative housing, the contacts comprising a plurality of first contacts and a plurality of second contacts, each first contact having a first contacting portion extending into the reception opening for mating with the electrical plug and a first tail portion for being mounted to a PCB, each second contact having a second contacting portion extending into the reception opening for mating with the electrical plug and a second tail portion for being mounted to the PCB, the first contacting portions and the second contacting portions being essentially located on a same side of the tongue plate and arranged in two rows along a front-to-back direction, the second tail portions being arranged in one row along a transverse direction perpendicular to the front-to-back direction, the first contacts comprising a first pair of differential contacts, the second contacts comprising a second pair of differential contacts, a third pair of differential contacts, and a second grounding contact located between the second pair of differential contacts and the third pair of differential contacts; wherein the first tail portions of the first pair of differential contacts are arranged along the front-to-back direction and located between the second tail portions of the second pair of differential contacts and the second tail portions of the third pair of differential contacts.

According to another aspect of the present invention, a connector having a reception opening for insertion of an electrical plug comprises: an insulative housing having a tongue plate extending into the reception opening; and a plurality of contacts retained in the insulative housing, the contacts comprising a plurality of first contacts and a plurality of second contacts, each first contact having a first contacting portion extending into the reception opening for mating with the electrical plug, a first retaining portion extending backwardly from the first contacting portion, and a first tail portion extending downwardly from a lateral edge of the first retaining portion for being mounted to a PCB, each second contact having a second contacting portion extending into the reception opening for mating with the electrical plug, a second retaining portion extending backwardly from the first contacting portion, and a second tail portion extending downwardly from a lateral edge of the second retaining portion for being mounted to the PCB, the first contacting portions and the second contacting portions being essentially located on a same side of the tongue plate and arranged in two rows along a front-to-back direction, each of the first and second tail portions having a first width along a transverse direction perpendicular to the front-to-back direction, and a second width along the front-to-back direction in condition that the first width is narrower than the second width, the first contacts comprising a adjacent first pair of differential contacts, the second contacts comprising a second pair of differential contacts, a third pair of differential contacts, and a second grounding contact located between the second pair of differential contacts and the third pair of differential contacts; wherein the first tail portions of the first pair of differential contacts extend from two adjacent lateral edges of the respective first retaining portions and located between the second tail portions of the second pair of differential contacts and the second tail portions of the third pair of differential contacts.

The foregoing has outlined rather broadly the features and technical advantages of the present invention in order that the detailed description of the invention that follows may be better understood. Additional features and advantages of the invention will be described hereinafter which form the subject of the claims of the invention.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a perspective view of a connector mounted on a PCB according to the present invention;

FIG. 2 is another perspective view of the connector mounted on the PCB shown in FIG. 1;

FIG. 3 is a partly exploded view of the connector shown in FIG. 1;

FIG. 4 is an exploded view of the connector shown in FIG. 1;

FIG. 5 is another exploded view of the connector shown in FIG. 1;

FIG. 6 is a perspective view showing an assembly of electrical contacts, a second insulative housing, and an optical module of the connector shown in FIG. 1; and

FIG. 7 is a perspective view showing an assembly of first contacts and the optical module of the connector shown in FIG. 1.

### DETAILED DESCRIPTION OF THE PREFERRED EMBODIMENT

In the following description, numerous specific details are set forth to provide a thorough understanding of the present invention. However, it will be obvious to those skilled in the art that the present invention may be practiced without such specific details. In other instances, well-known circuits have been shown in block diagram form in order not to obscure the present invention in unnecessary detail. For the most part, details concerning timing considerations and the like have been omitted inasmuch as such details are not necessary to obtain a complete understanding of the present invention and are within the skills of persons of ordinary skill in the relevant art.

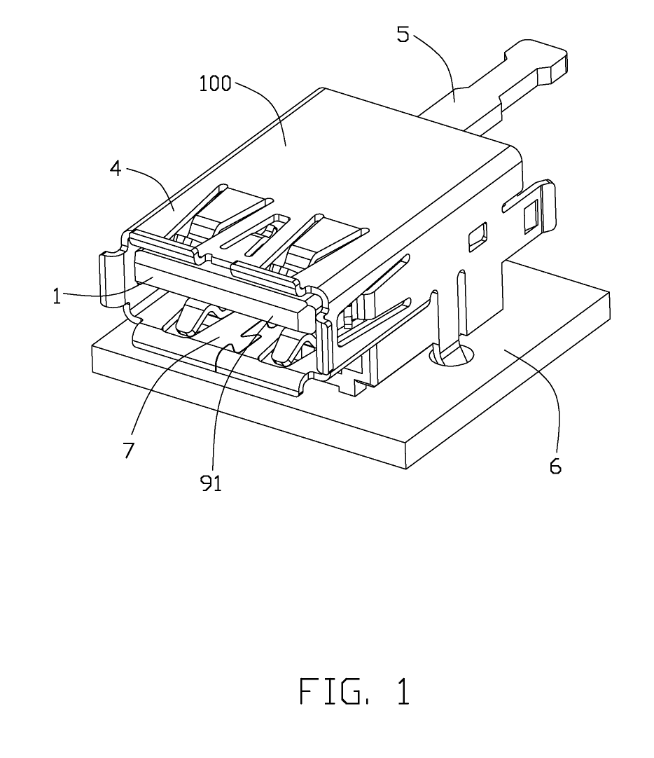

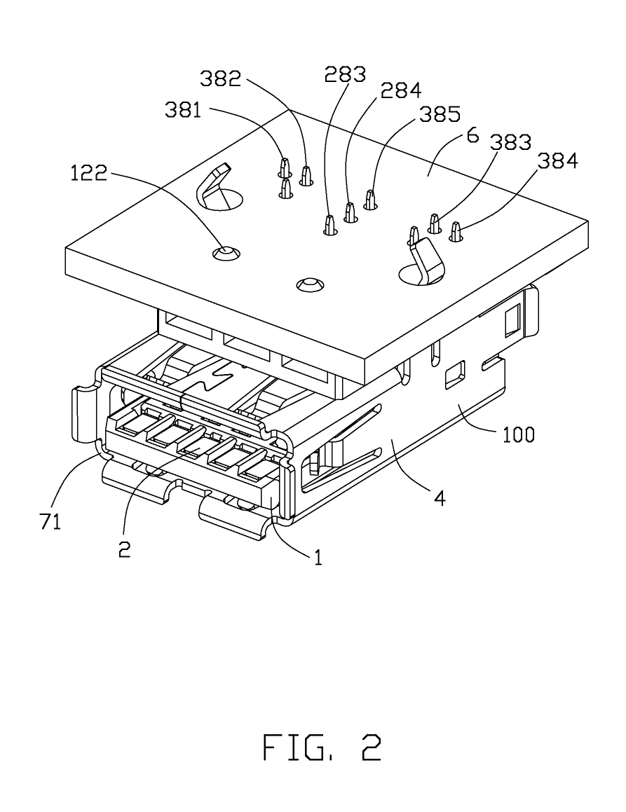

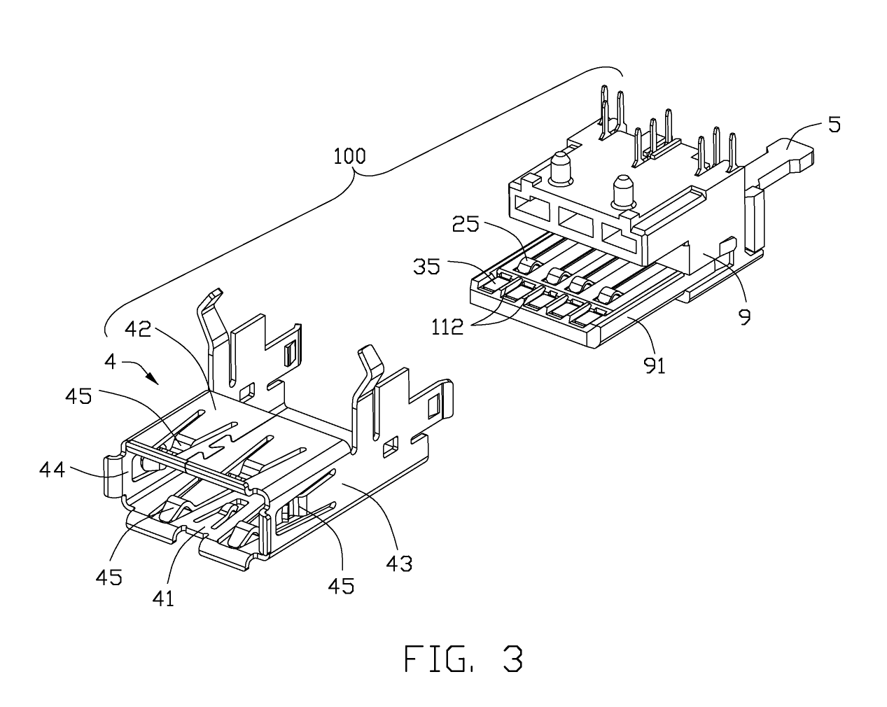

Referring to FIGS. 1-3, A connector 100 according to the present invention for being mounted to a printed circuit board (PCB) 6 is disclosed. The connector 100 is adapted to non-simultaneously receive a standard A-type USB 2.0 plug, a standard A-type USB 3.0 plug, and an optical plug. The connector 100 includes a first insulative housing 1, a set of electrical contacts 2 retained in the first insulative housing 1, a metal shell 4 enveloping the first insulative housing 1, and an optical module 5 retained in the first insulative housing 1. The connector 100 has a reception opening 7 for receiving a corresponding plug (not shown) and a front interface 71 formed at front of the reception opening 7 for the plug passing through so as to be received in the reception opening 7.

The first insulative housing 1 includes a base portion 10, a protruding portion 11 extending forwardly from an upper portion of the base portion 10, and a standoff 12 extending forwardly from a lower portion of the base portion 10. The protruding portion 11 has a receiving space 113 recessed upwardly from a lower surface thereof. The protruding portion 11 has a set of ribs 112 extending downwardly from the lower surface thereof and located at front of the receiving space 113, and forms a set of grooves 111 exposed to exterior and located between each two adjacent ribs 112. The standoff 12 has a pair of posts 122 extending downwardly from a lower side 121 thereof. The base portion 10 has a set of recesses 13 recessed forwardly from a rear end thereof for receiving the electrical contacts 2.

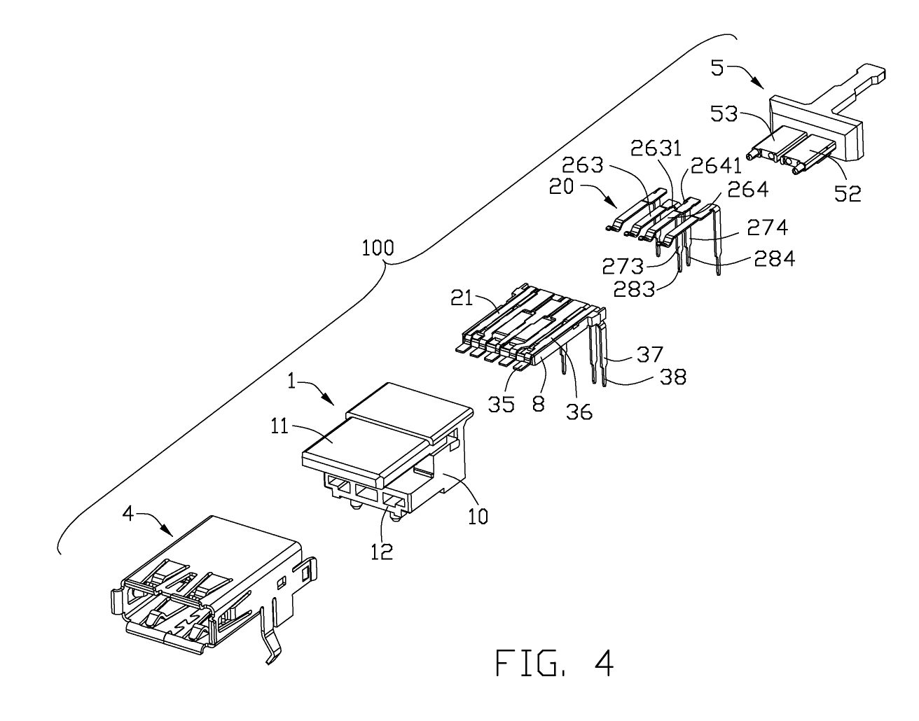

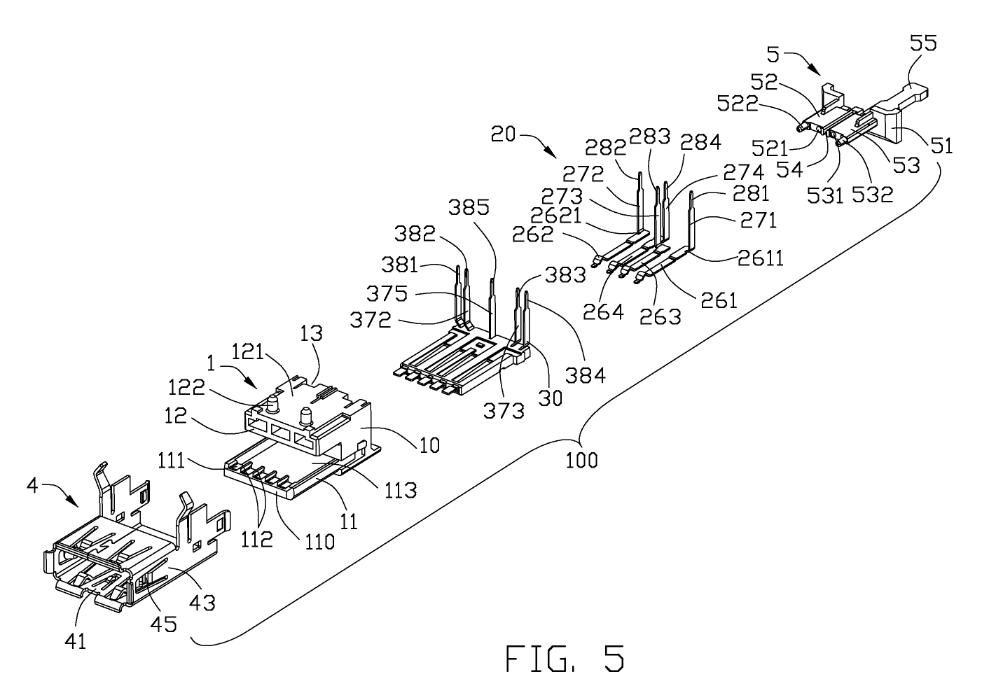

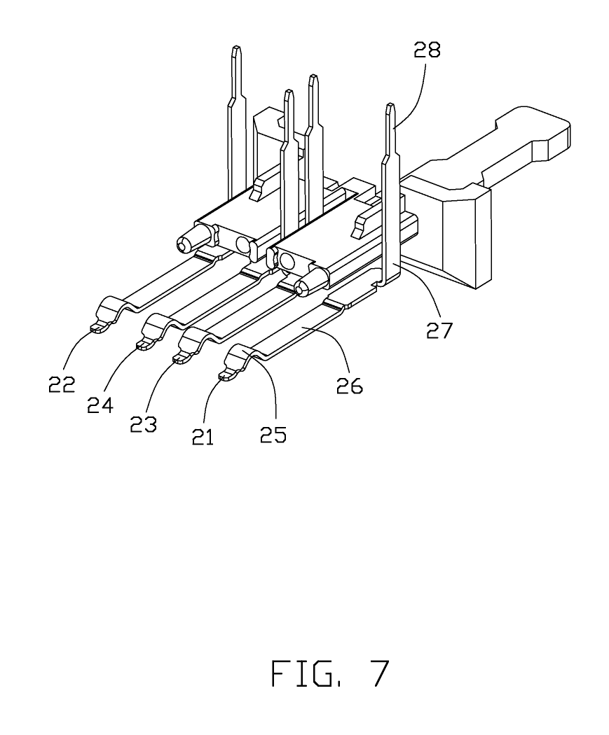

Referring to FIGS. 4 to 7, the contacts 2 are adapted for mating with the standard A-type USB 3.0 plug, and include a number of first contacts 20 and a number of second contacts 30. The first contacts 20 are adapted for mating with the standard A-type USB 2.0 plug and include a power contact 21 arranged at a left side thereof, a first grounding contact 22 arranged at a right side thereof, and a first pair of differential contacts 23, 24 located between the power contact 21 and the first grounding contact 22. The second contacts 30 include a second pair of differential contacts 31 arranged at a right side thereof, a third pair of differential contacts 32 arranged at a left side thereof, and a second grounding contact 33 located between the second and third pair of differential contacts 31, 32.

Each first contact 20 includes an arc resilient first contacting portion 25, a first retaining portion 26 extending backwardly from the first contacting portion 25 and along a horizontal plan, and a first tail portion having a first connecting portion 27 extending downwardly from the first retaining portion 26 and a first soldering portion 28 extending downwardly from a lower end of the first connecting portion 27 for being mounted onto the PCB 6. The first soldering portion 28 has a narrower width along a front-to-back direction B-B than that of the first connecting portion 27. The first contacting portions 25 are arranged in one row along a transverse direction A1-A1 perpendicular to the front-to-back direction B-B. The first tail portions are arranged in a front row along a transverse direction C2-C2 and a rear row along a transverse direction C2-C2. The first connecting portion 271 of the power contact 21 extends downwardly from a left side edge 2611 of the respective first retaining portion 261; the first connecting portion 272 of the first grounding contact 22 extends downwardly from a right side edge 2621 of the respective first retaining portion 262. Therefore, there will have an enlarged space between the first connecting portions 271, 272 of the power contact 21 and the first grounding contact 22 for the optical module 5 passing through. The first connecting portions 273, 274 of the first pair of differential contacts 23, 24 extend downwardly from two adjacent side edges 2631, 2641 of the respective first retaining portions 263, 264. Therefore, the distance between the first tail portions of the first pair of differential contacts 23, 24 will be reduced, and the impedance of the first pair of differential contacts 23, 24 will be decreased.

Referring to FIGS. 4-7, the connector 100 further includes a second insulative housing 8 integrally molded with the second contacts 30 to form a contact module. Each second contact 30 includes a stiff second contacting portion 35, a second retaining portion 36 extending backwardly from the second contacting portion 35 and along a horizontal plan, and a second tail portion having a second connecting portion 37 extending downwardly from the second retaining portion 36 and a second soldering portion 38 extending downwardly from a lower end of the second connecting portion 37 for being mounted onto the PCB 6. The second soldering portion 38 has a narrower width along the front-to-back direction B-B than that of the second connecting portion 37. The second contacting portions 35 are arranged in one row along a transverse direction A2-A2. The second tail portions are arranged in one row along a transverse direction C3-C3 and parallel to the row of the second contacting portions 35. The second connecting portions 381, 382 of the second pair of differential contacts 31 both extend downwardly from right side edges of the respective second retaining portions 36. The second connecting portions 383, 384 of the third pair of differential contacts 32 both extend downwardly from left side edges of the respective second retaining portions 36. Therefore, there will have an enlarged space between the second tail portions of the second pair of differential contacts 31 and the second tail portions of the third pair of differential contacts 32 for the optical module 5 passing through, and the interference between the second pair of differential contacts 31 and the third pair of differential contacts 32 can be reduced. The distances between the tail portions of each of the first pair of differential contacts 23, 24, the second pair of differential contacts 31 and the third pair of differential contacts 32 are substantially equal. Therefore, all of the first pair of differential contacts 23, 24, the second pair of differential contacts 31 and the third pair of differential contacts 32 will provide the same impedance. The first tail portions of the first pair of differential contacts 23, 24 are located in the midst of the second tail portions of the second pair of differential contacts 31 and the second tail portions of the third pair of differential contacts 32. Therefore, the interference among the first pair of differential contacts 23, 24, the second pair of differential contacts 31, and the third pair of differential contacts 32 can be reduced.

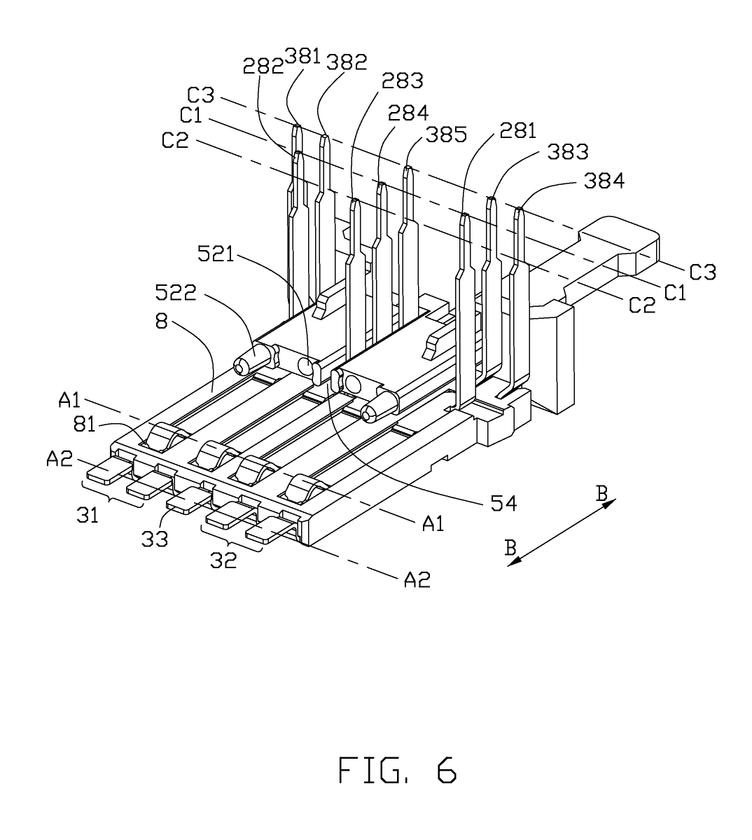

Referring to FIG. 6, the first soldering portions 28 and the second soldering portions 38 are arranged in three rows along the front-to-back direction B-B. The second soldering portions 38 are arranged in a back row furthest away from the front interface 71 and having a widest width, the first soldering portion 283 of one of the first pair of differential contacts 23, 24 is arranged in a front row nearest from the front interface 71, the other first soldering portions 281, 282, 284 of the first contacts 20 are arranged in a middle row and having a width narrower than that the back row and wider than the front row. The first soldering portions 28 and the second soldering portions 38 are arranged in five columns along the transverse direction, the first soldering portion 281 of the power contact 21 and the second soldering portion 383 of one of the third pair of differential contacts 32 are arranged in a first column along the front-to-back direction, the first soldering portion 282 of the first grounding contact 22 and the second soldering portion 382 of one of the second pair of differential contacts 31 are arranged in a second column along the front-to-back direction, the first soldering portions 283, 284 of the first pair of differential contacts 23, 24 and the second soldering portion 385 of the second grounding contact 33 are arranged in a third column along the front-to-back direction and located between the first column and the second column, the second soldering portion 384 of the other one of the third pair of differential contacts 32 and the second soldering portion 381 of the other one of the second pair of differential contacts 31 are arranged in two outermost columns respectively. The second contacting portions 35 protrude out of the second insulative housing 8. The second insulative housing 8 is received into the receiving space 113 and the second contacting portions 35 are retained in the respective grooves 111. The ribs 112 protrude downwardly out of the second contacting portions 35. In this embodiment, all of the transverse directions C1-C1, C2-C2, C3-C3, A1-A1 and A2-A2 are parallel to each other and perpendicular to the front-to-back direction B-B.

The first insulative housing 1 and the second insulative housing 8 are assembled together to form an insulative housing 9. The protruding portion 11 and a front part of the second insulative housing 2 which protrudes out of the base portion 10 are coupled together to form a tongue plate 91 protruding into the reception opening 7 for mating with a corresponding plug. The second insulative housing 8 has a set of passageways (not labeled) recessed upwardly from a lower surface thereof for receiving the first contacting portions 25. The first contacting portions 25 extend downwardly beyond the second contacting portions 35 and are located behind the second contacting portions 35. In another embodiment, the first insulative housing 1 and the second insulative housing 8 could be integrally formed as the insulative housing 9, the first contacts 20 and the second contacts 30 could be assembled to the insulative housing 9.

The metal shell 4 surrounds the insulative housing 9 and has a top wall 41, a bottom wall 42 parallel to the top wall 41, and a pair of side walls 43, 44 connecting the top wall 41 and the bottom wall 42. A set of spring tabs 45 are formed on the top wall 41, the bottom wall 42, and the side walls 43, 44. The spring tabs 45 protrude into the reception opening 7 for pressing against the corresponding plug.

Referring to FIGS. 4-6, the optical module 5 is assembled to the insulative housing 9 and is located under the second insulative housing 8. The optical module 5 has a main body 51, a first and second part 52, 53 extending forwardly from the main body 51 and parallel to each other, a slit 54 located between the first and the second part 52, 53, and a tail 55 extending backwardly and out of the insulative housing 9 from the main body 51. The optical module 5 has a pair of lenses 521, 531 disposed on front ends of the respective first and second parts 52, 53, and a pair of columniations 522, 532 extending forwardly from the front ends of respective first and second parts 52, 53 and located at two sides of the lenses 521, 531. The optical module 5 further includes a pair of fibers (not shown) assembled in the respective first and second parts to optically couple with the respective lenses 521, 531. The optical module 5 is assembled to the first insulative housing 1 from a rear end of the first insulative housing 1. The second connecting portion 375 of the second grounding contact 33 and the first connecting portions 273, 274 of the first pair of differential contacts 23, 24 pass through the slit 54. The first part 52 of the optical module 5 is located between the first connecting portion 272 of the power contact 21 and the first connecting portions 273, 274 of the first pair of differential contacts 23, 24, and located between the second connecting portion 375 of the second grounding contact 33 and the second connecting portions 372 of the third pair of differential contacts 32. The second part 53 of the optical module 5 is located between the first connecting portions 271 of the first grounding contact 21 and the first connecting portions 273, 274 of the first pair of differential contacts 23, 24, and located between the second connecting portion 375 of the second grounding contact 33 and the second connecting portions 373 of the second pair of differential contacts 31. Therefore, the arrangement of the contacts 2 can offers an enlarged space for the optical module 5 being assembled to the first insulative housing 1. The lenses 521, 531 are exposed to the reception opening 7 so as to mate with the corresponding plug. The columniations 522, 533 protrude into the reception opening 7 so as to mate with a pair of holes on the corresponding plug.

It is to be understood, however, that even though numerous, characteristics and advantages of the present invention have been set fourth in the foregoing description, together with details of the structure and function of the invention, the disclosed is illustrative only, and changes may be made in detail, especially in matters of number, shape, size, and arrangement of parts within the principles of the invention to the full extent indicated by the broad general meaning of the terms in which the appended claims are expressed.

What is claimed is:

1. A connector having a reception opening for insertion of an electrical plug, the connector comprising:
an insulative housing having a tongue plate extending into the reception opening; and
a plurality of contacts retained in the insulative housing, the contacts comprising a plurality of first contacts and a plurality of second contacts, each first contact having a first contacting portion extending into the reception opening for mating with the electrical plug and a first tail portion for being mounted to a PCB, each second contact having a second contacting portion extending into the reception opening for mating with the electrical plug and a second tail portion for being mounted to the PCB, the first contacting portions and the second contacting portions being essentially located on a same side of the tongue plate and arranged in two rows along a front-to-back direction, the second tail portions being arranged in one row along a transverse direction perpendicular to the front-to-back direction, the first contacts comprising a first pair of differential contacts, the second contacts comprising a second pair of differential contacts, a third pair of differential contacts, and a second grounding contact located between the second pair of differential contacts and the third pair of differential contacts; wherein
the first tail portions of the first pair of differential contacts are arranged along the front-to-back direction and located between the second tail portions of the second pair of differential contacts and the second tail portions of the third pair of differential contacts.

2. The connector according to claim 1, wherein the connector further comprises an optical module retained in the insulative housing and having a pair of lenses exposed to the reception opening, and a metal shell enclosing the insulative housing and the optical module.

3. The connector according to claim 2, wherein the first contacts further comprise a power contact and a first grounding contact, the first tail portions of the power contact and the first grounding contact are located at two sides of the first tail portions of the first pair of differential contacts.

4. The connector according to claim 3, wherein the reception opening has a front interface formed at a front end thereof for the electrical plug passing through, the first tail portions and the second tail portions are arranged in three rows along the front-to-back direction, the second tail portions are arranged in a back row furthest away from the front interface, the first tail portion of one of the first pair of differential contacts is arranged in a front row nearest from the front interface, the first tail portion of the other one of the first pair of differential contacts, the first tail portion of the power contact, and the first tail portion the first grounding contact are arranged in a middle row located between the back row and the front row.

5. The connector according to claim 4, wherein the first tail portion of the power contact and the second tail portion of one of the third pair of differential contacts are arranged in a first column along the front-to-back direction, the first tail portion of the first grounding contact and the second tail portion of one of the second pair of differential contacts are arranged in a second column along the front-to-back direction, the first tail portions of the first pair of differential contacts and the second tail portion of the second grounding contact are arranged in a third column along the front-to-back direction and located between the first column and the second column.

6. The connector according to claim 5, wherein the optical module comprises a main body, a first and second parts extending forwardly from the main body, and a slit located between the first and the second parts, the first part is located between the second tail portions of the second pair of differential contacts and the second tail portions of the second grounding portion, the second part is located between the second tail portions of the third pair of differential contacts and the second tail portions of the second grounding portion, the second tail portion of the second grounding contact and the first tail portions of the first pair of differential contacts pass through the slit.

7. The connector according to claim 6, wherein the lenses are disposed in the respective first and second parts, the optical module further comprises a pair of columniations extending forwardly from front ends of the respective first and second parts, the columniations are located at two outsides of the lenses.

8. The connector according to claim 1, wherein distances between the first tail portions of the first pair of differential contacts, the second tail portions of the second pair of differential contacts, and the second tail portions of the third pair of differential contacts are substantially equal.

9. The connector according to claim 1, wherein each first contact has a first retaining portion extending backwardly from the first contacting portion and retained in the insulative housing, each second contact has a second retaining portion extending backwardly from the second contacting portion and retained in the insulative housing, each first tail portion includes a first connecting portion extending downwardly from a lateral edge of the first retaining portion and being substantially perpendicular to the first retaining portion, and a first soldering portion extending downwardly from a lower end of the first connecting portion for being mounted to the PCB, each second tail portion includes a second connecting portion extending downwardly from a lateral edge of the second retaining portion and being substantially perpendicular to the second retaining portion, and a second soldering portion extending downwardly from a lower end of the second connecting portion for being mounted to the PCB.

10. The connector according to claim 1, wherein the insulative housing includes a first insulative housing having a base portion and a protruding portion extending forwardly from the base portion, and a second insulative housing assembled to the first insulative housing, the second insulative housing is integrally molded with the second contacts, the protruding portion has a receiving space recessed upwardly from a lower surface thereof, and a set of grooves communicating with the reception opening and located at front of the receiving space, the second insulative housing is received in the receiving space, the second contacting portions protrude out of the second insulative housing and are received in the respective grooves, the protruding portion and a front part of the second insulative housing which protrudes out of the base portion are coupled together to form the tongue plate.

11. The connector according to claim 1, wherein the contacts of the connector are adapted for mating with the standard A-type USB 3.0 plug, and the first contacts 20 are adapted for mating with the standard A-type USB 2.0 plug.

12. A connector having a reception opening for insertion of an electrical plug, the connector comprising:
an insulative housing having a tongue plate extending into the reception opening; and
a plurality of contacts retained in the insulative housing, the contacts comprising a plurality of first contacts and a plurality of second contacts, each first contact having a first contacting portion extending into the reception opening for mating with the electrical plug, a first retaining portion extending backwardly from the first contacting portion, and a first tail portion extending downwardly from a lateral edge of the first retaining portion for being mounted to a PCB, each second contact having a second contacting portion extending into the reception opening for mating with the electrical plug, a second retaining portion extending backwardly from the first contacting portion, and a second tail portion extending downwardly from a lateral edge of the second retaining portion for being mounted to the PCB, the first contacting portions and the second contacting portions being essentially located on a same side of the tongue plate and arranged in two rows along a front-to-back direction, each of the first and second tail portions having a first width along a transverse direction perpendicular to the front-to-back direction, and a second width along the front-to-back direction in condition that the first width is narrower than the second width, the first contacts comprising a adjacent first pair of differential contacts, the second contacts comprising a second pair of differential contacts, a third pair of differential contacts, and a second grounding contact located between the second pair of differential contacts and the third pair of differential contacts; wherein
the first tail portions of the first pair of differential contacts extend from two adjacent lateral edges of the respective first retaining portions and located between the second tail portions of the second pair of differential contacts and the second tail portions of the third pair of differential contacts.

13. The connector according to claim 12, wherein the second tail portions are arranged in one row along the transverse direction.

14. The connector according to claim 13, wherein the first tail portions of the first pair of differential contacts and the second tail portion of the second grounding contact are arranged in a third column along the front-to-back direction.

15. The connector according to claim 14, wherein the first contacts further comprise a power contact and a first grounding contact, the first tail portion of the power contact and the second tail portion of one of the third pair of differential contacts are arranged in a first column along the front-to-back direction, the first tail portion of the first grounding contact and the second tail portion of one of the second pair of differential contacts are arranged in a second column along the front-to-back direction.

16. The connector according to claim 15, wherein the connector further comprises an optical module retained in the insulative housing and having a pair of lenses exposed to the reception opening, and a metal shell enclosing the insulative housing and the optical module.

17. An electrical connector comprising:
an insulative housing defining a mating tongue with thereon opposite first and second surfaces in a vertical direction;
a plurality of first contacts disposed in the housing, each of said first contacts essentially defining a first horizontal section extending around the first surface and a first tail section extending essentially downwardly in said vertical direction from a rear side of the first horizontal section; and
a plurality of second contacts disposed in the housing, each of said second contacts essentially defining a second horizontal section extending along the second surface and a second tail section extending essentially downwardly in said vertical direction from a rear side of the second horizontal section;
the first contacts including a first differential pair side by side arranged with each other in a transverse direction perpendicular to said vertical direction, and the second contacts including two second differential pairs with a grounding contact therebetween in said transverse direction; wherein the first tail sections of said differential pair of the first contacts are aligned with each other in front-to-back direction perpendicular to both said vertical direction and said transverse direction, while the second tail sections of each of said second differential pairs are aligned with each other in the transverse direction.

18. The electrical connector as claimed in claim 17, wherein said the first tail sections of the first differential pair are located in a centerline area of the housing, and the second tail sections of each of the two second differential pairs are located by two opposite sides of said centerline area.

19. The electrical connector as claimed in claim 17, wherein the second tail section of the ground contact of the second contacts is essentially aligned with the first tail sections of the first differential pairs of the first contacts in said front-to-back direction.

20. The electrical connector as claimed in claim 17, wherein the first contacts further include a pair of ground/power contacts by two sides of the first differential pair in said transverse direction, and the first tail section of each of said ground/power contacts is offset from the second tail sections of the corresponding one pair of said two second differential pairs in the front-to-back direction so as to form a triangle arrangement together in a top view.
